(19) United States
(12) Patent Application Publication
(10) Pub. No.: US 2001/0053839 A1
(43) Pub. Date: Dec. 20, 2001

(54) Biomedical material and process for making same

(75) Inventors: Yasuharu Noishiki, Kanagawa-ken (JP); Teruo Miyata, Tokyo (JP); Hiroshi Ito, Tokyo (JP)

Correspondence Address: Leonard W. Sherman, Sherman & Shalloway, 413 N. Washington Street, Alexandria, VA, 22314, US

(73) Assignee: KOKEN CO. LTD., Tokyo (JP)

(21) Appl. No.: 09/878,261

(22) Filed: Jun. 12, 2001

(30) Foreign Application Priority Data
Jun. 19, 2000 (JP) 2000-183627

(51) Int. Cl. C08G 18/06; C08G 2/00; C08G 59/14

(52) U.S. Cl. 527/300; 527/301; 424/422

(57) ABSTRACT

Disclosed is a chemically crosslinked material, comprising a natural material or a derivative thereof having crosslinks formed by the combination of a primary crosslinking agent and an enhancer compound, wherein the crosslinks formed comprise crosslinks which include at least one additional hydroxyl group and/or at least one additional linear ether linkage as compared to crosslinks formed by the primary crosslinking agent alone. The materials according to preferred embodiments of the invention provide a chemically crosslinked material that has favorable antigenicity/flexibility characteristics.

### TECHNICAL FIELD OF THE INVENTION

This invention relates to chemically crosslinked natural materials or materials that have at least one selected derivative of a natural material as part of its constituents. More specifically, it also relates to a chemically crosslinked material in which crosslinks have been made by the combination of two components, at least one of which adds at least one additional hydroxyl group and/or straight-chained ether bond as a result of the chemical crosslinking. The chemically crosslinked material in accordance with preferred embodiments utilizes substantially the characteristics inherent to natural material such as being flexible and having cellular affinity, and they are suitable for use as biomaterial for constructing medical prostheses.

### BACKGROUND OF THE INVENTION

The natural material or material that has at least one selected derivative component from natural material as part of its constituents, especially that of which the main component is collagen, has excellent bio-adaptability and is a very important property as biomaterial. For this reason, all sorts of uses are planned along with various medical practices utilizing the material obtained from natural sources. Further, utilizing the absorbency that is one of the characteristics of natural material, many medical prostheses are also being developed that can be implanted in a body and can replace the autologous tissue after an implantation.

Medical prostheses that utilize specific structure and characteristics of biological tissue in its original form have been researched and developed. For example, a pig's heart valve that is chemically treated and retains its original form is used as an artificial heart valve for a replacement of a diseased cardiac valve. An artificial blood vessel, also chemically treated and maintaining its original form as an animal's blood vessel has been used in actual surgical practices. Further, human pericardium and cerebral dura mater are being used during a surgery as part of organic replacement membranes.

When such biological tissue is used in a living body, unless it is an autologous tissue, it is likely to cause rejection reaction for immunological reasons. Therefore, the majority of the current biological tissues are clinically used after they are chemically crosslinked in order to reduce their antigenicity.

Collagen is one of the major structural protein components of a living tissue. It is usually difficult to obtain collagen in a dispersed form as it presents itself in fibroid, fascicular, or reticular form after being crosslinked by a covalent bonding between individual collagen molecules. However, by utilizing protease that is specific to the crosslinked portion of a collagen fiber, or by developing techniques in making the collagen soluble in alkali, obtaining soluble collagen in a large amount becomes possible and allows its wide use as medical material.

Atelo-collagen is the collagen of which telopeptide has been removed by enzymatic solvation from its position at the end of a natural collagen molecule. The atelo-collagen not only has the characteristics that are hardly different from the collagen with natural telopeptides, but also has extremely low antigenicity and is excellent as biomaterial because the telopeptide, the portion that is strongly antigenic, is removed.

The soluble collagen such as atelo-collagen can be easily formed into various shapes from the solution. However, since formed product is soluble, it is necessary to make it insoluble by crosslinking. For example, atelo-collagen mentioned above is used as an injectable collagen for skin reconstruction.

On the other hand, there are occasions that the dispersed solution of fibroid collagen is produced without making it soluble. After shaping the dispersed solution of fibroid collagen, followed by crosslinking that makes it insoluble, a medical prosthetic material could be fabricated.

For instance, in order to prevent hemorrhaging from stitched or creased areas of a porous artificial fabric blood vessel or e-PTFE blood vessels that are highly porous, a procedure could be performed where the dispersed solution of collagen fibers is applied to the artificial blood vessel to clog the pores. The technology related to this procedure is disclosed in U.S. Pat. No. 3,272,204, U.S. Pat. No. 4,842,575, U.S. Pat. No. 5,197,977, U.S. Pat. No. 4,193,138, U.S. Pat. No. 5,665,114, and U.S. Pat. No. 5,716,660. The entire contents of the above-referred patents are incorporated herein by reference. For collagen used in those procedures, and in order to make the gelatin that is derived by thermal denature of collagen insoluble, the crosslinking using aldehyde as its crosslinking agents may be employed.

On the other hand, as described previously, there are occasions where biological tissue is used in its original form. For example, by sufficiently crosslinking a pig's heart valve using chemical agents such as glutaraldehyde, the biological degradability and the absorbency of the tissue are greatly reduced, and the valve can function as a heart valve in the patient's body for an extended period of time without degradation. Also, antigenicity due to trans-species implantation is suppressed and will not pose a problem. The patents for using glutaraldehyde for crosslinking medical prostheses have been disclosed in the U.S. Pat. No. 3,966,401; U.S. Pat. No. 4,247,292; in an article by O'Brien et al., (J. Thoracic and Cardiovascular Surgery, 1967, 53:392-397); an article by Reed. J. (Thoracic & Cardiovascular Surgery, 1969, 57:663-668); and an article by Carpentier et al., (J. Thoracic & Cardiovascular Surgery, 1969, 58:467-483). The entire contents of the above-referred patents and literature are incorporated herein by reference.

Usually, by crosslinking a biological tissue, one can expect such effects as added resistance for the biological tissue against biodegradation and absorption, increased physical strength and reduced antigenicity. Therefore, chemical crosslinking has been used for various medial prostheses obtained from natural material, and consequently, the application of the process has been extended in many areas with any newly added method such as heparinization.

For such objectives, other aldehydes such as formaldehyde and dialdehyde starch have been used as chemical crosslinking agents, and show favorable results. Further details about these agents are disclosed in the U.S. Pat. No. 3,066,401; U.S. Pat. No. 4,378,224; U.S. Pat. No. 4,082,507; U.S. Pat. No. 2,900,644; U.S. Pat. No. 3,927,422; and U.S. Pat. No. 3,988,728. The entire contents of the above-referred patents are incorporated herein by reference.

The agents widely used for chemical crosslinking other than aldehydes are isocyanates, and they are known for low cytotoxicity. The products crosslinked with these agents are widely utilized clinically, and their detailed characteristics are disclosed in U.S. Pat. No. 5,141,747 and U.S. Pat. No. 4,052,943. The entire contents of the above-referred patents are incorporated herein by reference.

Other crosslinking agents are polyepoxy compounds. The reaction between an epoxy group and an amino group is very slow compared to that between aldehydes such as glutaraldehyde and an amino group, but sufficient crosslinking can be achieved by adjusting the time, temperature and the concentration of hydrogen ions. The detailed characteristics are disclosed in the U.S. Pat. No. 3,931,027; U.S. Pat. No. 5,124,438; U.S. Pat. No. 5,134,178; U.S. Pat. No. 5,354,336; U.S. Pat. No. 5,591,225; U.S. Pat. No. 5,874,537; and U.S. Pat. No. 5,880,242. The entire contents of the above-referred patents are incorporated herein by reference.

However, a chemically treated material by those crosslinking agents might not be optimal for use as a medical prosthesis. For instance, crosslinking could cause loss of flexibility that characterizes a natural material. That is, the flexibility of a material may not be maintained following a chemical crosslinking process. Also, the chemically crosslinked material tends to calcify long time after implantation. Consequently, various methods have been studied in order to prevent calcification. These are, for example, disclosed in the U.S. Pat. No. 4,323,358; U.S. Pat. No. 4,402,697; U.S. Pat. No. 4,481,009; U.S. Pat. No. 4,729,139; U.S. Pat. No. 4,838,888; and U.S. Pat. No. 5,002,566. However, effective method in preventing calcification has not yet been achieved.

Further, these crosslinking agents are not necessarily harmless to the cells. Regarding the cellular toxicity, Chvapil et al. (J. Biomed. Mater. Res. 1980, 14: 753-764) report that there have been problems for non-reactive crosslinking agents to gradually release from the implant material long time after implantation; consequently, the released non-reactive crosslinking agent causes ill effect to the surrounding tissues and cells.

The fact that the chemically crosslinked medical prosthesis could harden and lose its flexibility of a natural material (subsequently becoming calcified and cell-toxic), is a remarkable phenomenon for a biological tissue containing large amounts of collagen. For instance, a natural heart valve is quite flexible and the valve opens and closes even with a slight pressure difference. However, when a pig's heart valve is crosslinked using glutaraldehyde, the valve hardens and becomes unable to open and close with such a small pressure gradient. Thus, the lack of flexibility is a big problem clinically, but no effective means to solve this problem has yet been developed.

### SUMMARY OF THE INVENTION

Preferred embodiments of the invention disclosed herein provide a chemically crosslinked material where the drawbacks of the current technologies as mentioned above have been minimized or eliminated, and wherein such material has favorable antigenicity/flexibility characteristics.

In accordance with one preferred embodiment, there is provided a chemically crosslinked material, comprising a natural material or a derivative thereof having crosslinks formed by the combination of a primary crosslinking agent and an enhancer compound, wherein the enhancer compound provides at least one additional hydroxyl group and/or at least one additional linear ether linkage as compared to crosslinks formed by the primary crosslinking agent alone.

In accordance with another preferred embodiment there is provided a chemically crosslinked material, comprising a natural material or a derivative thereof having crosslinks formed therein. The crosslinks comprise those formed by the combination of a primary crosslinking agent selected from aldehydes, isocyanates and epoxies, and an enhancer compound, represented by one of the following chemical formulae: H₂N—R(OH)—NH₂, HO—R—NH₂, H₂N—R—O—R—NH₂, H₂N—R(OH)—O—R—NH₂, and HO—R—O—R—NH₂, wherein R is a substituted or unsubstituted chain comprising 1-8 atoms selected from carbon, oxygen and nitrogen. Crosslinks formed by the combination include at least one additional hydroxyl group and/or at least one additional linear ether linkage as compared to crosslinks formed by the primary crosslinking agent alone.

In accordance with another preferred embodiment there is provided a chemically crosslinked material, comprising a collagen-containing material having multiple crosslinks between its collagen strands, wherein the crosslinks comprise enhanced crosslinks formed by the combination of a primary crosslinking agent and an enhancer compound. The enhanced crosslinks include at least one additional hydroxyl group and/or at least one additional linear ether linkage as compared to crosslinks formed by the primary crosslinking agent alone.

In accordance with a preferred embodiment, there is provided a method for preparing a chemically crosslinked material. The method comprises crosslinking a natural material or a derivative thereof with a primary crosslinking agent and an enhancer compound, wherein crosslinks formed by crosslinking comprise crosslinks which include at least one additional hydroxyl group and/or at least one additional linear ether linkage as compared to crosslinks formed by the primary crosslinking agent alone.

In accordance with yet another preferred embodiment, there is provided a method for preparing chemically crosslinked collagenous material comprising placing collagen or collagenous tissue in a solvent and adding crosslink forming materials to the solvent whereby crosslinked material is formed. The crosslink forming materials comprise a primary crosslinking agent selected from the group consisting of aldehydes, isocyanates and epoxies, and an enhancer compound, represented by one of the following chemical formulae: H₂N—R(OH)—NH₂, HO—R—NH₂, H₂N—R—O—R—NH₂, H₂N—R(OH)—O—R—NH₂, and HO—R—O—R—NH₂, wherein R is a substituted or unsubstituted chain comprising 1-8 atoms selected from carbon, oxygen and nitrogen. In one embodiment, substantially all of the enhancer compound is added to the solvent and left in contact therewith for about 5 to about 30 hours prior to the addition of the primary crosslinking agent. In another embodiment, wherein the enhancer and the primary crosslinking agent are added together, including but not limited to where such addition occurs all at the same time or in sequence with one following shortly after the other, either all or in smaller aliquots.

The above methods preferably also include processing the crosslinked material with glycine.

Preferred enhancers include compounds represented by one of the following chemical formulae: H₂N—R(OH)—NH₂, HO—R—NH₂, H₂N—R—O—R—NH₂, H₂N—R(OH)—O—R—NH₂, and HO—R—O—R—NH₂, wherein R is a substituted or unsubstituted chain comprising 1-8 atoms selected from carbon, oxygen and nitrogen. Such preferred enhancers include 1,3-diamino-2-hydroxypropane, glucosamine, galactosamine, triethyleneglyceroldiamine, glycerol glycidyl amine, and 2(2-aminoethoxy)ether. Preferred primary crosslinking agents include formaldehyde, glutaraldehyde, dialdehyde starch, hexamethylene diisocyanate, triethylene diisocyanate, glycerol triglycidyl ether, ethylene glycol diglycidyl ether, polypropylene glycol diglycidyl ether, trimethylol propane polyglycidyl ether, diglycerol polyglycidyl ether, polyglycerol polyglycerol polyglycidyl ether, and sorbitol polyglycidyl ether. Preferred natural materials to be crosslinked are collagen-containing materials including blood vessels, urinary ducts, esophagus, small intestine, large intestine, luftrohre, perineurium, and peritendon, cerebral dura mater, cardiac sac membrane, amniotic membrane, cornea, mesenterum, peritoneum, pleura, diaphragm, urinary bladder membrane, fascia, aponeurosis, chorion, heart valves, venous valves, tendon, and skin.

### BRIEF DESCRIPTION OF THE DRAWING

Additional aspects and features of preferred embodiments of present invention will become more apparent and better understood from the following Detailed Description of Preferred Embodiments, when read with reference to the accompanying drawing.

FIG. 1 is a schematic drawing of a cantilever-type testing device used for testing the rigidity/flexibility property of the material.

### DETAILED DESCRIPTION OF PREFERRED EMBODIMENTS

The co-inventors have studied diligently the crosslinking reactions based on various chemical crosslinking agents, and also a variety of characteristics of the products (crosslinked material) obtained. Consequently, we have found that favorable antigenicity/flexibility balance can be obtained when crosslinking agents that are capable of newly introducing hydroxyl group and/or straight-chained ether bond are introduced to the crosslinked material.

The chemically crosslinked material disclosed herein is based on the above-mentioned knowledge and findings. To be exact, it involves the material obtained by chemical crosslinking of a natural material, or a material that has at least one part of its constituents selected from the derivatives of a natural material. It is also characterized by the increase of one hydroxyl group and/or straight-chained ether bond per individual molecule as a result of the chemical crosslinking.

The reasons that the favorable antigenicity/flexibility balance is achieved in our crosslinked material which has the above-mentioned composition, are described as follows.

That is, the fact that favorable antigenicity/flexibility balance was unable to be achieved up till now, is based on the observations that the hydrophilic property of the material as a whole was reduced as the hydrophilic functional groups (amino group and others) were consumed during crosslinking reaction.

Against this, in accordance with preferred embodiments herein, by way of newly introducing hydroxyl groups and/or straight-chained ether bonds even when the hydrophilic functional groups (amino group and others) are consumed in the reaction during a crosslinking process, the hydrophilic characteristics are preferably maintained at least comparable to the level the material had. Therefore, the hydrophilic property of the crosslinked material as a whole is preferably not reduced, resulting in favorable antigenicity/flexibility balance.

As for the hydrophilic groups which will be introduced during crosslinking, amino group and carboxyl group are considered. However, when amino groups are utilized, there is a possibility that they too, may be consumed in the crosslinking reaction.

Further, when a large amount of carboxyl groups are introduced, the increase of the negative charge of the crosslinked material makes it possible to cause side effects such as calcification which is described later.

The inventors have found that when hydroxyl groups are added, the hydrophilic property of the material can be preserved as with amino groups, and only little side effects such as calcification are seen as mentioned previously.

Also, according to the inventors, it is established that the reason that favorable antigenicity/flexibility balance can be achieved even when the straight-chained ether bond is introduced newly to the crosslinking material is due to the increase in the bending property of the induction site stemming from the so-called “free joint” property of the ether bond. As a result, this will allow preservation of flexibility in the crosslinked area within the material and the flexible property inherent to the biological material is restored.

It should be noted that the explanations and discussions of the hypothesis behind the materials and methods disclosed herein, as well as those of the prior art, are merely the hypotheses of the inventors in view of their present work and understanding of the technology. Such discussions are presented as one possible explanation for the success of the preferred embodiments disclosed herein and the failures and/or shortcomings of particular prior art methods and materials; it is not intended that the invention necessarily be bound to the validity or correctness of the hypotheses presented herein.

Prior Art

The reasons that favorable antigenicity/flexibility balance was not attained for the chemically crosslinked material in the past are discussed below.

According to the inventors' knowledge, based on the experimentation and studies of the crosslinked material and its physical property presented by a variety of crosslinking agents, it is hypothesized that losing flexibility is related to the molecular structure of the crosslinking agents. It is also conceived that it is heavily related to the moisture content, water absorbency, and hydrophilicity of the crosslinked material.

For example, the crosslinking agent such as glutaraldehyde which has five carbon molecules in a row may, by its chemical structure, result in adding both hardening and hydrophobic properties to the material simultaneously and as a result, the moisture content and water absorbency may be reduced and further hardening may occur. Therefore, it becomes necessary to take measures to bring flexibility to the crosslinking site by not using the crosslinking agents that have carbon molecules in straight chains in a row such as glutaraldehyde. In case these agents are used, it is necessary to prepare separately the agents that have molecules with flexible property, and then perform crosslinking reaction in the presence of these agents.

Also, when the crosslinking agents have low molecular weights, namely those with short molecular chains, the flexibility of the material may be lost as the mobility in the material is restricted by the agent's short molecular chain. For example, formaldehyde has a short molecular chain causing a phenomenon such as moving-range constraint. Therefore, it becomes necessary to employ crosslinking agents with long molecular chains. However, as the molecular weight becomes larger, it becomes difficult for the agents to permeate into the space between individual molecules, making it difficult to introduce sufficient crosslinking into the interior. As a result, the problem could not be solved by simply using a crosslinking agent with larger molecular weights.

It then becomes necessary to develop crosslinking agents capable of preserving flexibility and bending properties even when their molecular chains are short. Consequently, it has become an issue with regard to the material used in the past, to develop and select such crosslinking agents and be able to perform crosslinking reaction in coexistence of another substance, for example an enhancer, as well as setting the conditions for such crosslinking.

It is well known to introduce carboxyl group as a method to retain the hydrophilic property of the material. For instance, as seen in disposable diapers, by adding a large amount of carboxyl group onto the surface fibers, the carboxyl group that is negatively charged repels each other as the diaper becomes wet, and a large quantity of the water molecules is taken into the space between the molecules that are repelled from each other and negatively charged. Then the material displays its ability to hold water to the point where the drawn-in water cannot escape from the space. This is seen not only in disposable diapers, but also is a method utilized in many products already.

However, in case of medical prostheses, such as implantable valves and vessels, it may disturb the local ion balance within the body when such charge becomes strong. For example, when the negative charge is increased, since the calcium ions in the body are positively charged, they are easily attracted to the areas where a strong negative charge exists, and may cause deposits in high concentration becoming a factor inducing the problem of calcification that is described later. Therefore, enhancing both the hydrophilic property and moisture content can be highly effective.

The problem of calcification, according to the inventors' knowledge, is considered as a phenomenon that is also encouraged by the material being hydrophobic. The glutaraldehyde-treated collagen material is already known for its tendency to cause calcification in the body, as has been described earlier. According to the inventors, the reason is that the fluidity of water within the material is reduced because a biological material containing large amounts of collagen becomes hydrophobic when treated by glutaraldehyde after crosslinking. If calcium ions form a nucleus under those conditions, the concentration of the calcium ions in the area is reduced making it possible for further entering of calcium ions. Then, the calcium deposit may start forming additionally at the nucleus site previously formed, and it is suggested that the calcium may deposit continuously becoming a vicious cycle and manifests itself as a phenomenon of calcification.

The phenomenon that the hydrophobic medical prostheses can easily cause calcification is not limited to those made from biological material, but also seen among those made of synthetic macromolecules. For instance, e-PTFE is obtained by stretching polytetrafluoroethylene (PTFE) very abruptly causing countless cracks, providing the material bendable and flexible properties, and it is widely utilized as a medical material. However, Tomizawa et al. (ASAIO Journal, 1998,44:496-500) has reported this type of calcification on e-PTFE graft.

Therefore, it becomes necessary to achieve an environment that allows maintaining the dynamic water movement in hydrophilic conditions that the biological material has in its interior even when treated by crosslinking. How to achieve this condition for the traditional material has remained as a problem.

Description of the Preferred Embodiments

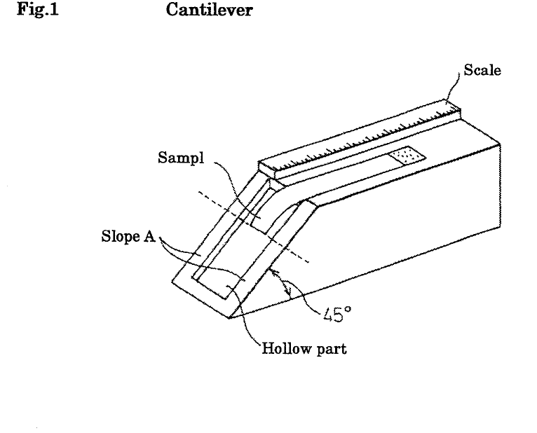

Preferred embodiments and aspects are disclosed below, referring to FIG. 1 as necessary. The “part” and “%” noted below that indicate quantities and ratios, are by mass or weight unless noted otherwise.

The chemically crosslinked material herein refers to the material that is obtained by chemically crosslinking a natural material or a material which contains derivative(s) of the natural material. The crosslinking process results in an increase of at least one hydroxyl group and/or at least one straight-chained ether bond in the majority of crosslinks formed, the greater the majority the better.

As long as an increase of at least one hydroxyl group and/or straight-chained ether bond per one molecule occurs as a result of crosslinking, the method is not particularly restricted. Such hydroxyl group or ether bond is preferably provided by a class of compounds referred to herein as “enhancers” or “enhancer compounds.” This class of compounds includes numerous compounds which vary in structure, molecular weight, functionality and other properties, but have the common feature of providing a hydroxyl group or straight-chain ether bond either in the compound itself or as a result of the inclusion of that compound in a crosslink (formed during the reaction). That is, regarding the introduction of a hydroxyl group for example, any of the following methods, among others, can be utilized: the crosslinking agent has a hydroxyl group in its molecular structure; the enhancer has a group which produces a new hydroxyl group through the crosslinking reaction; inserting an enhancer that has at least a hydroxyl group during crosslinking, premixing a crosslinking agent with an enhancer that has at least one hydroxyl group prior to the crosslinking reaction; and the like.

Similarly, regarding the introduction of straight-chained ether bonds for example, any of the following methods can be utilized: the crosslinking agent itself has an ether bond; producing a new ether bond through crosslinking reaction; use of an enhancer which has at least one ether bond during crosslinking, premixing a crosslinking agent with an enhancer which has at least one ether bond prior to the crosslinking reaction; and the like.

Verification of Increase of Hydroxyl Group/Ether Bond

The increase of a hydroxyl group and/or ether bond can be favorably verified as an increase in hydrophilic property by for example, measuring the contact angle that is explained below.

Raw Material

The material to be crosslinked, in accordance with preferred embodiments, is not particularly restricted as long as it is a natural material or a material that contains at least one selected derivative of a natural material as part of its constituents. The natural material can be a raw substance, can be derived from natural sources or can be a material which is substantially identical as said material of natural origin and is artificially manufactured (for example, synthetic, semi-synthetic, genetically manipulated, or cell-fused).

The natural material or its derivatives preferably includes, but is not limited to, natural tissue harvested from human or animal (after genetic manipulation, if necessary), collagen, a solution that contains collagen derivative, or a shaped object constructed from the dispersion solution of collagen.

For the natural tissue, various types of tissues that are harvested from a body in their original condition, or after removing the adjacent tissues (fat or cells, etc.) can be used. Suitable materials include, but are not limited to, tubular materials such as blood vessels, ureter, small intestine, large intestine, esophagus, bronchial tube, and neural sheaths; membrane materials such as cerebral dura mater, pericardium, amnion, cornea, luftrohre, mesentery, peritoneum, pleura, diaphragm, urinary bladder membrane, fascia, and velamentum; valvular materials such as cardiac valves and venous valves; tendons and/or skin. When animal tissues are utilized, the transplantation is heterologous, but if they are sufficiently rinsed and sterilized, they pose little problem for their use. For example, tissues from human, cow, horse, pig and goat can be used.

On the other hand, for the source of collagen material, any animal or substance from tissues can be used, as well as collagen that is obtained by genetic recombination. When using the collagen that is singularly isolated from the animal tissues such as skin and tendon to construct a collagen object, one can use either insoluble, soluble, or collagen that is made soluble.

The types of collagen are not particularly limited and they can be for example, tendon collagen harvested from the tendon of an animal, hide collagen harvested from animal skin, acid soluble collagen that is an acid soluble component from an animal tissue dissolved by acid, salt soluble collagen that is a salt soluble component, enzyme soluble collagen that is dissolved out by enzymes, and alkali soluble collagen which is made soluble in the alkaline condition. Further, they can be chemically modified collagen that is obtained by chemically modifying the above-mentioned types of collagen. For example, the collagen modified by acylation such as using succinylation, or collagen modified by methylation, can be used.

Further, the products formed into either membrane, laminar, annular, tubular, spherical, powdery, spongy, filamentous, or cylindrical shape, from the above noted collagen or the solution or dispersion solution that contains the collagen derivatives as components, can be used. Additionally, a non-porous structure that is formed into any of such shapes as laminar, membrane, annular, tubular, filamentous or stringy, from macromolecular material with bio-adaptability can be used. Or, a porous structure which is either cloth, knitted, stretched, or mesh and is either coated with, soaked in, or kneaded with the solution or dispersion solution made of the above noted collagen as comprising elements, can also be used.

Preferred Crosslinking Processes

Next, in accordance with preferred methods of crosslinking, any crosslinking agent, including those commonly used today including but not limited to aldehydes, isocyanates, or epoxy crosslinking agents, can be employed as the primary crosslinking agent for the crosslinking reaction.

From the point of easily obtaining favorable flexibility and other desired characteristics, preferred methods and materials made therefrom use at least one enhancer compound having a in accordance with the following formulae from (1) through (5):

(1) H₂N—R(OH)—NH₂

(2) HO—R—NH₂

(3) H₂N—R—O—R—NH₂

(4) H₂N—R(OH)—O—R—NH₂

(5) HO—R—O—R—NH₂

In the above formulae, the molecule R represents a carbon chain which may include branching, double/triple bond, or ring structure and may also contain a hetero-atom (O, N and/or S). The molecular weights (average molecular weight in case of mixture, from polymer to oligomer) of the crosslinking agents mentioned in the above (1)-(5), are preferably less than 1×10⁴ Daltons, more preferably less than 5×10⁴, with less than 3×10⁴ being especially preferred.

The methods utilizing the enhancer compounds (1)-(5) to take part in the crosslinking reactions, preferably result in said enhancer compounds (1)-(5) reacting with at least one functional group of the natural material comprising the source and/or of the crosslinking agents.

Such methods may include, but are not limited to, having the interior of the natural material to be crosslinked soaked with any enhancer compound from (1)-(5) beforehand, followed by the addition of the primary crosslinker, or making a mixture solution of both the crosslinking agent and an enhancer compound, such as those from (1)-(5) first, and then adding collagenous material for crosslinking in the premixed solution. Considering the possibility that the crosslinking agents may be consumed by the enhancer compound, it is preferred that the first method noted above be used, however, the second method, as well as other methods in accordance with the present invention, are also suitable.

Preferred crosslinking agents (i.e. primary crosslinking agents) include, but are not limited to, the aldehydes such as glutaraldehyde, formaldehyde, and dialdehyde starch; the isocyanate compounds such as hexamethylene diisocyanate, and triethylene diisocyanate; and the epoxy compounds such as glycerol triglycidyl ether, ethylene glycol diglycidyl ether, polypropylene glycol diglycidyl ether, trimethylolpropane polyglycidyl ether, diglycerol polyglycidyl ether, polyglycerol polyglycidyl ether, sorbitol polyglycidyl ether, and the like.

Among these, when the aldehydes and isocyanates crosslinking agents are used, it is extremely desirable to introduce an enhancer, including those compounds (1)-(5) above for the crosslinking reaction since these primary crosslinking agents do not have either a hydroxyl group or ether bond either in their structure or when they form crosslinks.

Some of the epoxy compounds contain a hydroxyl group or ether bond, either in their original form or having such a group or bond formed upon undergoing the crosslinking reaction. For instance, diglycerol polyglycidyl ether, polyglycerol polyglycidyl ether, and sorbitol polyglycidyl ether are such examples. Therefore, although epoxy compounds may be used alone, the characteristics of the material may be improved by the use of an enhancer to provide at least one additional hydroxyl group and/or ether bond.

Further, in respect to the reaction between an epoxy group and an amino group of the substance such as collagen which exist inside the natural material, the reaction will cause an opening of the ring where the epoxy group is located, creating one hydroxyl group from every reaction. Therefore, even when the epoxy compounds other than diglycerol polyglycidyl ether, polyglycerol polyglycidyl ether, or sorbitol polyglycidyl ether are used, or even when any compound from (1)-(5) is not used, it is possible to increase the number of hydroxyls within the material. Accordingly, the crosslinking which utilizes epoxy compounds can introduce hydroxyls without using any compound from (1)-(5), although use of an enhancer is preferred.

However, as when glutaraldehyde is used, it is more favorable to utilize an enhancer compound, including those compounds from (1)-(5) in the crosslinking reaction by using a method such those described herein, including allowing the enhancer to permeate through the material first thereby allowing further introduction of a large amount of hydroxyls and ether bonds into the natural material.

Compounds according to formula (1), include at least the two terminal two amino groups and at least one hydroxyl. Examples of such compounds include, but are not limited to, 1,3-diamino-2-hydroxypropane {chemical formula: H₂NCH₂CH(OH)CH₂NH₂}, and chitosan.

Compounds according to formula (2), include at least one terminal amine and at least one hydroxyl. Such compounds include, but are not limited to, glucosamine and galactosamine. Further, amino acids such as serine and threonine can be included, but as these contain carboxyl group beside hydroxyls, using glucosamine or galactosamine is more desirable.

Compounds according to formula (3), include at least the two terminal two amino groups and at least one straight-chained ether bond. Such compounds include, but are not limited to, triethylene-glycol-diamine which has the following formula {H₂N(CH₂)₂OCH₂CH₂CH₂O (CH₂)₂NH₂}.

Compounds according to formula (4) include at least the two terminal two amino groups ,at least one straight-chained ether bond, as well as at least one hydroxyl-containing R group. Such compounds include, but are not limited to, glycerol-glycidyl-amine which has the following formula {H₂N(CH₂)₃OCH₂CH(OH)CH₂O(CH₂)₃NH₂}.

Compounds according to formula (5) include at least the terminal amino and hydroxyl groups and at least one straight chain ether bond. Such compounds include, but are not limited to, 2-(2-aminoethoxy)ethanol which has the following formula {H₂N(CH₂)₂O(CH₂)₂OH}.

For the compounds in accordance with formulae (1) through (5) above, the R groups are preferably have one or more of the following characteristics: fairly short in length, high flexibility, and/or hydrophilicity. The R groups may contain additional hydroxyl groups and ether bonds above and beyond that which are noted in the formulae. Alkane-based groups are preferred over alkene and alkyne-based R groups due to their greater flexibility.

The conditions that crosslinking takes place can vary depending on the characteristics of each crosslinking agent. Depending on which agent is being used, the concentration of the crosslinking agent, the concentrations of the enhancer and primary crosslinking agent, the reaction temperature of the crosslinking agent's solution, and the concentration as well as the reaction time of hydrogen ions can all differ. Such parameters can be adjusted according to the needs of the particular combination used.

Epoxy Compounds as Crosslinking Agents

In the embodiments in which aldehydes and isocyanates are used as primary crosslinking agents, there is a tendency for the crosslinking reaction to progresses rather quickly, and for the surface of the material to be crosslinked strongly and also rapidly. On the other hand, in comparison to the aldehydes and isocyanates, the epoxy compounds generally present slower reaction rate, which helps in preserving flexibility, retaining of hydrophilic property, and preventing or reducing calcification subsequent to the crosslinking process. Therefore, for the foregoing reasons and also the easiness of introducing crosslinking into the interior of the material, epoxy compounds are especially preferred crosslinking agents.

Solvent

As for the solvent for crosslinking, there are no particular restrictions as long as the desired crosslinking reaction (hydroxyl group and/or straight-chained ether bond is newly created) is achievable in the solvent. Preferred solvents for aldehydes such as glutaraldehyde, formaldehyde and dialdehyde starch for example, include: aqueous solvent such as water, phosphate buffer, and sodium carbonate solution, and organic solvent such as mixture of water and methanol or ethanol, as well as mixed solvent of those mentioned above.

For isocyanate compounds such as hexamethylene diisocyanate and trimethylene diisocyanate, preferred solvents include organic solvent including methanol, ethanol, propanol, acetone, hexane and toluene.

And as for epoxy compounds such as glycerol triglycidyl ether, ethylene glycol glycidyl ether, polypropylene glycol glycidyl ether, trimethylol propane polyglycidyl ether, diglycerol polyglycidyl ether, polyglycerol polyglycidyl ether, and sorbitol polyglycidyl ether, preferred solvents include aqueous solvent including water, phosphate buffer, and sodium carbonate solution, and organic solvent such as methanol and ethanol, or the mixture of these solvent can be favorably used.

Preferred Crosslinking Reaction Conditions

For crosslinking reaction, the crosslinking agents together with at least one enhancer compound, preferably represented by formulae (1)-(5), can be added to the solvent containing the natural material or derivative thereof. The addition may proceed in any order, and may be all at once, alternating one component with the other, having one component follow the other component, or by premixing the two components and then adding them to the solvent containing the natural material or derivative thereof. Alternatively, one may let one of the compounds, preferably the enhancer, permeate through the material first and then allow the material come into contact with the crosslinking agents.

As for the amount of enhancer to be added, it is preferred that the total number of moles of the amino group be in the range from 10% through 100% (preferably 20˜80%) per total number of moles of either aldehyde or isocyanate functional group contained in the crosslinking agents.

In regard to epoxy compounds, as described earlier, since they can create hydroxyl group from the reaction between an amino group and epoxy group without adding any compound from (1)-(5), and since ether bonding can be introduced additionally, it is possible to obtain flexibility without adding any compound from (1)-(5) necessarily. However, it may be more effective if any compound from (1)-(5) are added.

During the crosslinking reaction, the pH of the solvent is preferably within pH 5 to pH 12 for any of the crosslinking agents, more preferably within the neutral and alkaline range (pH 7 to 12). Further, as for the concentration of the crosslinking agents, 0.01 to 10% by weight is preferred, although any suitable concentration may be used depending upon the properties desired in the resultant material. The reaction time greatly differs depending on the types of crosslinking agents being used. For example, shorter times are acceptable for aldehydes, such as between 0.5 to 24 hours, whereas between 3 to 48 hours is preferred for epoxy compounds.

For those processes which result in residual functional groups (those which have not been reacted), the possible toxicity of these groups may be controlled by deactivating them using glycine. Therefore, it is preferred that the material is treated with glycine after crosslinking reactions take place. The reaction conditions for treating with glycine can preferably be the same as the conditions for crosslinking.

The temperature for crosslinking reaction may vary depending on the material to be crosslinked, and for the product made from biological tissues, there may be no problem if it is less than the in vivo temperature (37° C.). When the product made from either collagen solution or from its dispersed solution, it may pose no problem if the temperature is lower than the denaturation temperature. For example, a problem such as denaturation may not occur during the reaction if the temperature is maintained below 30° C. for those which have denaturation temperature in the vicinity of 40° C. which include the acid soluble collagen and enzyme soluble collagen. And the temperature should be less than 25° C. for those which have the denaturation temperature at around 35° C. and those include alkali soluble collagen and chemically modified collagen.

However, if the temperature becomes too low, the reaction efficiency becomes slow, so it is preferred that the temperature to be above 15° C. The temperature of above 20° C. is especially desirable for the reaction using epoxy since its reaction is generally temperature-dependent, with the reaction progressing faster as the temperature increases. Therefore, from the aspect of crosslinking using epoxy compounds, there is an advantage contrarily, that an accurate control of reaction rate is easily performed when controlling the degree of reaction during the process by taking both the temperature and time into consideration.

Heparinization

Protamine can be combined to crosslinking material by mixing protamine during crosslinking. By soaking the crosslinked material combined with protamine in heparin solution, one can coat the surface of the material with heparin, and it is also possible to add anti-thrombotic property. The protamine used for this can be taken from any animals, or it can be recombinant protamine. Also, it can be a protamine containing histone, and any one produced from either inorganic or organic acids and salt is desirable, such as protamine sulfate or protamine chloride. Further, synthetic and basic polyamino acids such as polylysine and polyarginine, can be used.

The method of heparinization of material is an application of the technologies noted by Special development 1982, No. 65054, Special development 1985, No. 168857, Special development, 1985, No. 177450, U.S. Pat. No. 4,704,131, and U.S. Pat. No. 4,833,200. When hydroxyl or ether bonding is introduced to the material by adding any compound from (1)-(5) or other enhancers, it allows protamine to covalently bond simultaneously while the material is being crosslinked in the conditions close to its natural property. Further, by ionic bonding of heparin, effective anti-thrombotic property can be added to the material maintaining its inherent characteristics.

In this regard, it is desirable to either add the solution which has protamine concentration of 0.1 to 10% (preferably 0.3 to 5%), to the crosslinking agents described before, or crosslink after soaking the material in the protamine solution first. It is desirable to soak the material in the protamine solution for the duration of more than 30 minutes (preferably 30 minutes to about 16 hours). When soaking the material, the permeation for example, can be enhanced in a shorter time by exerting a pressure ranging from 20 to 50 mmHg.

Tissue Treatment

It is possible to use a piece of tissue harvested from an animal, maintaining its original form. For example, crosslinking can be performed while retaining the valvular structure of a heart valve or a venous valve from an animal, or maintaining cardiac membrane's structure, and they can be used in their original shape and conditions.

Typically, a chemically crosslinked medical prosthetic material shall keep its function for long time after implantation and do not decompose or being absorbed. For this type of usage, higher rate of crosslinking is preferred to such a level that at least 70% or more (preferably more than 80%) of the amino group within the material is consumed in the process of crosslinking.

Organ Treatment

Medical prosthetic materials may be created by combining a structural body made of macromolecular material and the material made of solution or dispersed solution of a component taken from the tendon or skin of a human or an animal. The macromolecular structural body in any shape can be used, but it is generally in laminar, membrane, annular, cylindrical, filamentous or stringy shape for non-porous structural body, or for porous structure, either cloth, knitted, stretched, or mesh can be suitably used. These structures can be used after being either coated with, soaked in or kneaded with the solution or dispersed solution containing the substance from tendon or skin as mentioned above.

For the solution, collagen which is a main structural component of the tendon and skin, is made soluble and extracted. The method that was earlier described can be used to make collagen soluble. And for the dispersed solution, the tendon and the skin are mechanically crushed and are dispersed into water or physiological saline solution. Further, this type of dispersed solution shows different characteristics depending on its pH. Generally, in an acidic condition, the collagen from the tendon and skin will swell up making the solution viscous, while in a neutral condition, this does not happen resulting in usually less viscous solution.

Synthetic macromolecules, natural material, or material that contains at least part of their derivatives can be used as macromolecular material. For the natural material or material which contains its derivatives partially, include the material obtained from tissue as described before. These materials can be utilized by being coated with, soaked in, or kneaded with the solution or dispersed solution containing substance from tendon or skin.

For the aspect of usage, the natural material which comprises macromolecular material, or the material which at least partially contains its derivatives, is often considered desirable to be resolved and absorbed within 6 months after implanted into an mammalian body. For such usage where absorption of the material is expected within 6 months, a low crosslinking rate is desired where less than 60% (preferably less than 50%) of the amino group within the material is consumed by crosslinking.

When the materials are used in the premise of being absorbed, from the point that they do not impede replacing autologous tissue, it is desirable that they do not remain in the body for any duration longer than about 6 months.

In the embodiment that the material is used concurrently with another synthetic macromolecular material which is intended to remain in the body permanently, there is no particular restrictions for the macromolecular material if it can be used for its intended purposes (medical purposes, for example). For instance, polyethylene, polypropylene, polymethylpentene, polyurethane, polyvinyl chloride, polycarbonate, polystyrene, polyamide, fluoroplastic, silicon resin, carbon resin, or their copolymer, mixture, or their derivatives are used for medical purposes.

It is not desirable if these synthetic macromolecular materials are resolved and absorbed in the mammalian body within 6 months subsequent to their implantation since these materials have synthetic macromolecular structure as their basic skeleton and are intended to be integrated with the surrounding tissue and are also used by either being coated, permeated, or kneaded with either the solution or the dispersed solution obtained from tendons or skin. Therefore, if these synthetic macromolecular structures are resolved and absorbed within the six-month period, it becomes difficult for the structures to maintain their shapes and achieve their purposes.

However, it is desirable to be resolved and absorbed within the six-month period for the biological materials that have synthetic macromolecular or its derivative as their basic framework that are either coated, permeated or kneaded with either the solution or the dispersed solution obtained from tendons or skin. In this case, after the material is resolved and absorbed in the body, the host cell and tissue may invade into the area, and may result in replacing the biological material that was crosslinked.

Hydrophilicity

Some preferred embodiments involve introducing hydroxyl group or ether bond newly to the material after it is crosslinked. As a result, compared to crosslinking by traditional method, it can increase the level of hydrophilic property of the crosslinked material. By introducing ether bonding, it allows the material preserve its flexibility compared to that crosslinked by a traditional method.

The evaluation of hydrophilic level can be performed by measuring the contact angle using the falling-drop method, for example. For instance, from the fact that the surface of a horse's pericardium facing the heart is smooth, the contact angle after crosslinking can be measured on this smooth surface for the evaluation of the hydrophilic property.

Through the experiment by the inventors, it was found that the contact angle for the pericardium which was crosslinked with glutaraldehyde was about 75 degrees. On the other hand, if it was permeated with glycerol glycidylamine representing a compound containing both a hydroxyl group and straight-chained ether bond prior to crosslinking with glutaraldehyde, the contact angle was found to be 45 degrees indicating its hydrophilic property has increased.

Flexibility

The introduction of at least one hydroxyl group or ether bond as part of or after the crosslinking process increases the level of flexibility of crosslinked material significantly compared to that resulting from a traditional crosslinking method.

The evaluation of the flexibility level can be measured by a method using a cantilever or represented by the pressure gradient necessary to cause opening and shutting of heart valves, for instance.

Through the experiment by these inventors, the rigidity/flexibility measurement of pericardium crosslinked with glutaraldehyde as measured by a cantilever, showed approximately 41 mm. On the other hand, the pericardium that was crosslinked with glutaraldehyde after permeated with glycerol glycidylamine representing a compound containing both a hydroxyl group and straight-chained ether bond was 36 mm, revealing that the flexibility had been preserved.

The measurement of flexibility of material such as a heart valve, can be obtained by measuring the pressure difference between before and after opening and shutting of the valve. Generally, a normal venous valve will open and shut with the pressure difference less than 5 mm Hg. The valve that was crosslinked with glutaraldehyde as in a conventional method showed pressure of 54 mm Hg. On the other hand, the one crosslinked with glutaraldehyde after permeated with glycerol glycidylamine representing a compound containing both a hydroxyl group and straight-chained ether bond showed rigidity and flexibility measurement of 39 mm Hg indicating preservation of the flexibility.

Applications

The crosslinked materials that were produced in this manner, can be utilized favorably as medical prosthetic materials, specifically as an artificial dura mater, artificial connective tissue, artificial chest membrane, artificial pleura, artificial skin, artificial chest wall, artificial abdominal wall, artificial peritoneum, adhesion prevention membrane, artificial bladder, artificial pericardium, artificial epimysium, and as a wound-healing promoting agent.

Further, chemically crosslinked materials can be utilized as a replacement prosthesis for biological tissue such as cardiac chamber wall, arterial wall, venous wall, bronchial tube, bile duct, digestive tube, ureter, bladder wall, abdominal wall, peritoneum, epimysium, neural sheaths, and tendon sheath. Or they can also be used as surgical auxiliary material such as adhesion preventing membrane, wound-healing promoting agent, as well as membrane for tissue repair.

The following non-limiting examples present certain of the preferred embodiments.

### EXAMPLE NO. 1

Equine cardiac membrane was obtained fresh from a slaughterhouse, and after removing the surrounding fat tissue as much as possible, it was submerged in the phosphate solution containing 0.01% ficin for 24 hours to remove all the protein except collagen. It was then sufficiently rinsed with phosphate buffer solution (pH=7.0, with 0.1% streptomycin, and 0.1% amphotericin B). The membrane was cut into pieces in the size of 2 cm×10 cm, and they were used as membrane materials (Material 1).

A membrane (Material 1) which was obtained by the above description, was put into 1.0% glutaraldehyde/phosphate buffer solution (pH 7.4) and was crosslinked for one hour at room temperature. It was rinsed thoroughly with normal saline solution and a membrane crosslinked with glutaraldehyde was obtained (GA 1).

Another piece of membrane as described above (Material 1) was put into 1.0% glutaraldehyde/phosphate buffer solution (pH 7.4) of which 1% contained glycerol glycidylamine representing a compound that has both a hydroxyl group and straight-chained ether bond. It was crosslinked for one hour at room temperature then rinsed, and a membrane crosslinked with glutaraldehyde, also bonded with hydroxyl and straight-chained ether bonding at the crosslinked site, was obtained (GA 2). The structural formula for glycerol glycidylamine is H₂N(CH₂)₃OCH₂CH(OH)CH₂O(CH₂)₃NH₂.

A membrane noted above (Material 1) was freeze-dried. Then, the dried membrane was put into 3.0% hexamethylene diisocyanate/methanol solution containing 1,3-diamino-2-hydroxypropane, and was crosslinked for three hours at room temperature. It was then adequately rinsed with distilled water and thus, a membrane crosslinked with isocyanate was obtained (IC 1).

Another piece of membrane (Material 1) was soaked in 1% glycerol glycidylamine solution representing a compound having both a hydroxyl group and straight-chained ether bonding for 24 hours at room temperature. The membrane was then freeze-dried. Then the membrane treated as described was put in 3.0% hexamethylene diisocyanate/methanol solution also containing 1,3-diamino-2-hydroxypropane. It was crosslinked for three hours at room temperature before it was sufficiently rinsed with distilled water. Thus, a membrane crosslinked with isocyanate, and also bonded with hydroxyl and ether bonding at the crosslinked site was obtained (IC 2).

Another membrane (Material 1) was put into 0.1M sodium carbonate/50% ethanol solution (pH 11.5-11.8) and 5.0% ethylene glycol diglycidyl ether (EX810 from Nagase Chemical Co., Ltd., Japan) was added and was crosslinked for five hours. It was then thoroughly rinsed with distilled water and thus, a membrane crosslinked with epoxy was obtained (EX 1) Another membrane (Material 1) was soaked in 1% solution of glycerol glycidyl amine which was selected as representing a compound having both a hydroxyl group and straight-chained ether bonding, for 24 hours at room temperature. Then the membrane was put into 0.1M sodium carbonate/50% ethanol solution (pH 11.5-11.8) and 5.0% ethylene glycol diglycidyl ether was added. It was crosslinked for five hours and was rinsed sufficiently with distilled water and thus, a membrane crosslinked with epoxy, also bonded with a hydroxyl group and ether bonding at the crosslinked site, was obtained (EX 2).

### EXAMPLE NO. 2

From the weight measurement of both dry weight obtained from freeze-drying, and wet weight (before freeze-dried) of each membrane from Example 1: (Material 1); (GA 1); (GA 2); (IC 1); (IC 2); (EX 1); and (EX 2), the amount of water content for each membrane against its dry weight was calculated. It was found that the water content of each of these membranes, (Material 1), (GA 1), (GA 2), (IC 1), (IC 2), (EX 1), and (EX 2), were 75%, 65%, 69%, 72%, 70%, 74%, and 76% respectively.

As a result, it was noticed that crosslinking of a heart membrane using glutaraldehyde and isocyanate lowers the moisture content of the membrane, but it is improved by newly introducing at least one new hydroxyl group and ether bonding to the process. This tendency was also found similarly effective when epoxy was used for crosslinking, and it was made clear that the moisture content was improved by crosslinking with epoxy alone.

### EXAMPLE NO. 3

In order to measure the rigidity/flexibility of each membrane obtained in the Example no. 1, namely (Material 1), (GA 1), (GA 2), (IC 1), (IC 2), (EX 1), and (EX 2), the rigidity/flexibility were measured by a flexibility testing method, using a cantilever as shown in FIG. 1 which is a rigidity/flexibility measurement method for textile material. Each of (Material 1), (GA 1), (GA 2), (IC 1), (IC 2), (EX 1), and (EX 2) was found to have rigidity/flexibility measured as 4 mm, 41 mm, 36 mm, 30 mm, 25 mm, and 6 mm, respectively.

As a result, it was apparent that the cardiac membranes crosslinked with glutaraldehyde and isocyanate were both hardened, and flexibility was preserved by introduction of hydroxyl and ether bonding. Further, it was also obvious that a similar effect was obtained when crosslinked with epoxy compounds.

### EXAMPLE NO. 4

In order to evaluate the degree of tearing force for each membrane obtained in Example no. 1, namely (Material 1), (GA 1), (GA 2), (IC 1), (IC 2), (EX 1), and (EX 2), the force required for tearing the membrane was measured. It was measured using a standard suture retention test published by ANSI/AAMI (American National Standards Institute/Association for the Advancement of Medical Instrumentation). The measurement method involved hooking a surgical suture at 2 mm from the edge of each membrane and stretching it until the membrane is torn, measuring the load required for the tearing to occur.

As a result of this measurement, the tearing force required for each membrane, (Material 1) (GA 1), (GA 2), (IC 1), (IC 2), (EX 1), and (EX 2), was 0.7 kg, 0.9 kg, 0.9 kg, 0.8 kg, 0.8 kg, 0.8 kg and 0.8 kg respectively.

From this experiment, it became clear that dynamic strength is more increased by crosslinking process compared to the membrane that was not treated by crosslinking. And it was also noticed that crosslinking of a cardiac membrane using glutaraldehyde as well as isocyanate had the same level of strength as those that were crosslinked using epoxy.

### EXAMPLE NO. 5

Each membrane obtained from the Example no. 1, namely (Material 1), (GA 1), (GA 2), (IC 1), (IC 2), (EX 1), and (EX 2), was measured for its rate of crosslinking based on the consumed amount of E (epsilon)-amino group which is a residual group from lysine in the collagen component of each membrane. The measurement was performed using TNBS method (referred to: Analytical Biochem., 1969, 27:273).

According to the TNBS method, the level of consumed amino group was found by calculating the ratio of consumed amino group of each membrane against the (Material 1) being set as 0%. From this, the crosslinking rate for each membrane, namely (Material 1), (GA 1), (GA 2), (IC 1), (IC 2), (EX 1), and (EX 2), were 0%, 85%, 82%, 90%, 86%, 79%, and 76%, respectively.

As a result, it was found that each crosslinking method provided the crosslinking rate of more than 70% across all membranes. Further, for the samples where glycerol glycidyl amine was used as a representative compound for having both hydroxyl group and straight-chained ether bonding, the crosslinking rate was lower than those samples that did not have the corresponding compound introduced.

### EXAMPLE NO. 6

The degree of hydrophilic property for each membrane from Example no. 1, namely (Material 1), (GA 1), (GA 2), (IC 1), (IC 2), (EX 1), and (EX 2), was measured by finding the contact angle of each membrane using the falling-drop method. Each membrane has two sides, one facing the heart and the other side facing the peritoneum. The side facing the heart was generally smooth and the opposite side appeared fluffy when inspected in detail. For this reason, the measurement of the contact angle was performed on the smooth side.

Through the measurement of the contact angle by the falling-drop method, the contact angle for each membrane, namely (Material 1), (GA 1), (GA 2), (IC 1), (IC 2), (EX 1), and (EX 2), was found. They were 15 degrees, 65 degrees, 45 degrees, 68 degrees, 42 degrees, 20 degrees, and 18 degrees, respectively.

From this, it was found that crosslinking using glutaraldehyde and isocyanate reduces the hydrophilic property of the membrane. On the other hand, crosslinking using epoxy reduces the hydrophilic property only a little. In this evaluation, for the samples where glycerol glycidyl amine was introduced as a representative compound of having both hydroxyl group and straight-chained ether bonding, it was found that the degree of hydrophilic property was significantly increased compared to those which did not have the compound introduced.

### EXAMPLE NO. 7

Each membrane which was obtained through the steps in Example no. 1, namely (Material 1), (GA 1), (GA 2), (IC 1), (IC 2), (EX 1), and (EX 2), was submerged in a 0.1M sodium carbonate solution with 5% glycine for ten hours. After they were crosslinked accordingly, they were labeled as (Material 1′), (GA 1′), (GA 2′), (IC 1′), (IC 2′), (EX 1′), and (EX 2′), respectively. This treatment is further crosslink the previously un-crosslinked region with the amino group from glycine.

A 1 cm square sample was cut from each membrane from the above noted (Material 1), (GA 1), (GA 2), (IC 1), (IC 2), (EX 1), and (EX 2), as well as from each membrane from (Material 1′), (GA 1′), (GA 2′), (IC 1′), (IC 2′), (EX 1′), and (EX 2′). Then they were inserted into the subcutaneous tissue of the back of four-week old rats using sterile techniques.

Four weeks after the insertion, the inserted membranes were harvested along with the surrounding tissue and fixed with 10% formaldehyde before they were embedded with paraffin and the sectioned fragments were created for optical microscope. The reaction to foreign body was then qualitatively determined after they were stained with hematoxylin/eosin.

In order to evaluate the degree of reaction against the foreign body, the levels of necrosis of the surrounding tissue, appearance of macrophage, appearance of foreign body giant cells, as well as formation of encapsulating tissue were observed, and they were evaluated comprehensively. The level of foreign body reaction was divided into five levels and standard value was established with 5+ indicating strong foreign body reaction and 0 being no foreign body reaction. According to the values, each sample was evaluated.

The foreign body reactions against each membrane, namely (Material 1), (GA 1), (GA 2), (IC 1), (IC 2), (EX 1), and (EX 2), as well as (Material 1′), (GA 1′), (GA 2′), (IC 1′), (IC 2′), (EX 1′), and (EX 2′), received the values of +1, +5, +4, +3, +2, +2, and +1, and further +1, +4, +4, +3, +2, +2 and +1, respectively.

As a result, it was observed that the glutaraldehyde crosslinked membranes caused strong appearance of foreign body reaction, and the next being isocyanate. The reaction against the crosslinked membrane using epoxy was less compared to the two mentioned above. Also, it was found that treating with glycine seemed to have an effect of somewhat reducing the foreign body reaction.

### EXAMPLE NO. 8

Using the samples obtained from the experiment where each membrane from Example no. 1, namely (Material 1), (GA 1), (GA 2), (IC 1), (IC 2), (EX 1), and (EX 2), as well as each membrane from (Material 1′), (GA 1′), (GA 2′), (IC 1′), (IC 2′), (EX 1′), and (EX 2′) was cut into a square shape with each side being 1 cm and followed by insertion of the cut fragment into the subcutaneous tissue in the back of four-week old rats, evaluation for calcification was performed using the sectioned fragments stained in von Kossa staining for optical microscopic evaluation.

For the evaluation of calcification, the level of calcification was divided into five levels based on the concentration of calcification and the extension of the calcified area with +5 indicating the heaviest calcification and 0 being no calcification. Each sample was studied against these standards.

The degree of calcification for each membrane from (Material 1), (GA 1), (GA 2), (IC 1), (IC 2), (EX 1), and (EX 2), and also for each from (Material 1′), (GA 1′), (GA 2′), (IC 1′), (IC 2′), (EX 1′), and (EX 2′) was evaluated using the standards described above. The degrees for each membrane were 0, +2, +2, +1, +1, 0, and 0, and also 0, +2, +1, +1, +1, 0, and 0 in the respective order.

From this, it was found that crosslinking with glutaraldehyde showed strong calcification, and crosslinking with isocyanate indicated moderate degree of calcification. No calcification was identified with crosslinking using epoxy. Further, treating with glycine did not seem to show any effect in terms of preventing calcification.

### EXAMPLE NO. 9

Fresh jugular veins from a cow were obtained from a slaughterhouse and after removing the surrounding fat tissue as much as possible, they were soaked in distilled water for two hours to create swollen cell components by osmotic pressure. They were then treated with ultrasound for 30 seconds, and the swollen cells were destroyed selectively without damaging collagen fibers and elastic fibers. Thus, natural fibroid tubes were obtained.

From among these tubes created from jugular veins, the tubes which had internal diameter of 20 mm and also had three valvular leaves in a venous valve were selected, and their length was adjusted to 12 cm, making sure of the existence of a venous valve within the length. Thus, the natural tubes with valves were obtained (Material 3).

A tube obtained in such a way (Material 3) was put into 1.0% glutaraldehyde/phosphate buffer solution (pH 7.4) and was crosslinked for one hour at room temperature. It was then rinsed and a tube crosslinked with glutaraldehyde was obtained (GA 3).

A tube from the above mentioned (Material 3) was put into 1.0% glutaraldehyde/phosphate buffer solution of which 1% also contained glycerol glycidyl amine representing a compound having both at least one hydroxyl and straight-chained ether bonding. The structural formula of the solution is shown as H₂N (CH₂)₃OCH₂CH(OH)CH₃O(CH₂)₃NH₂. The tube was crosslinked for one hour at room temperature and was rinsed sufficiently with normal saline solution. Thus, a tube crosslinked with glutaraldehyde and bonded with at least one hydroxyl and ether bonding at the crosslinked site was obtained (GA 4).

Another tube as described above (Material 3) was freeze-dried. It was then put into 3.0% hexamethylene diisocyanate/methanol solution which also contained 1,3-diamino-2-hydroxypropane and it was crosslinked for three hours at room temperature before adequately rinsed with distilled water. Thus, a tube crosslinked with isocyanate was obtained (IC 3).

Another tube described above (Material 3) was soaked for 24 hours at room temperature, in 1% solution of glycerol glycidyl amine representing a compound having both hydroxyl and straight-chained ether bonding. It was then freeze-dried. Next, the tube which was treated as described was put into 3.0% hexamethylene diisocyanate/methanol solution which also contained 1,3-diamino-2-hydroxypropane, and was crosslinked for three hours and was rinsed sufficiently with distilled water. Thus, a tube crosslinked with isocyanate and also bonded with a compound having hydroxyl and ether bonding at the crosslinked site was obtained (IC 4).

Another tube described above (Material 3) was put into 0.1M sodium carbonate 50% ethanol solution (pH 11.5˜11.8), and 5.0% ethylene glycol glycidyl ether (EX810 from Nagase Chemical Co., Ltd., Japan) was added to the solution, and the tube was crosslinked for five hours before sufficiently rinsed with distilled water. Thus, a tube crosslinked with epoxy was obtained (EX 3).

Another tube as described above (Material 3) was soaked in 1% solution containing glycerol glycidyl amine, representing a compound having both hydroxyl and straight-chained ether bonding, for 24 hours at room temperature. Next, the tube treated as described was put into 0.1M sodium carbonate 50% ethanol solution (pH 11.5˜11.8) and 5.0% ethylene glycol glycidyl ether (EX810 from Nagase Chemical Co., Ltd., Japan) was added into the solution, and was crosslinked for five hours. It was then rinsed sufficiently with distilled water. Thus a tube crosslinked with epoxy and bonded with hydroxyl and ether bonding at the crosslinked site was obtained (EX 4).

### EXAMPLE NO. 10

In order to observe the flexibility of the tube's valvular leaves, normal saline solution was flown through each tube obtained as described in the above example, namely (Material 3), (GA 3), (GA 4), (IC 3), (IC 4), (EX 3), and (EX 4). The condition of the valve's opening and closing was observed based on the pressure difference existing between the front and behind the valve, and the flexibility of the valvular leaves was evaluated.

From the evaluation of each tube, the pressure differences needed for opening and closing of the valve for each (Material 3), (GA 3), (GA 4), (IC 3), (IC 4), (EX 3), and (EX 4) were 2 mmHg, 45 mmHg, 39 mmHg, 45 mmHg, 42 mmHg, 5 mmHg and 4 mmHg, respectively.

From the result, it was found that higher pressure gradient was required for the opening and closing of valves treated with glutaraldehyde and isocyanate, since their valves were hardened. On the other hand, when treated with hydroxyl and ether bonding, the valves somewhat preserved flexibility and the pressure required for opening and closing was less. When crosslinked with epoxy, the valves were as flexible as that without any treatment, and the treatment that was performed to improve moisture content was also found effective.

### EXAMPLE NO. 11

In order to make protamine permeate into the surface of the lumen of the tubes that were obtained in the Example no. 9 (Material 3), 1% protamine sulfate solution was injected into the lumen maintaining the inside pressure at 20 mmHg for 20 minutes (Material 4).

A tube described above (Material 4) was put into 1.0% glutaraldehyde/phosphate buffer solution (pH 7.4), and was crosslinked for one hour at room temperature. It was rinsed sufficiently and thus, the tube crosslinked with glutaraldehyde was obtained. It was then followed by soaking the tube in 1% heparin solution, pH 5.0, for one hour, and the tube was rinsed with distilled water for two hours. The tube was then preserved in 70% alcohol. Thus a heparinized tube with valve crosslinked with glutaraldehyde was obtained (GA 5).

Another tube as noted above (Material 4) was put into 1.0% glutaraldehyde/phosphate buffer solution (pH 7.4) of which 1% was also glycerol glycidyl amine representing a compound having both hydroxyl and straight-chained ether bonding. The structural formula of the solution is shown as H₂N(CH₂)₃OCH₂CH(OH)CH₂O(CH₂)₃NH₂. The tube was crosslinked for one hour at room temperature and was rinsed sufficiently rinsed. Thus, a tube crosslinked with glutaraldehyde and also bonded with hydroxyl and ether bonding was obtained.

Then the tube was heparinized using the same method as described above for crosslinking the tube with glutaraldehyde. Thus a heparinized tube with valve crosslinked with glutaraldehyde and bonded with hydroxyl and ether bonding was obtained (GA 6).

Another tube as noted above (Material 3) was freeze-dried. The tube was put into 3.0% hexamethylene diisocyanate/methanol solution which also contained 1,3-diamino-2-hydroxypropane, and was crosslinked for three hours at room temperature. It was then rinsed thoroughly with distilled water and thus, a tube crosslinked with isocyanate was obtained. Further, the tube was treated with protamine in the same manner as described earlier, and was also heparinized as the same way as crosslinked tube with glutaraldehyde. Thus, a heparinized tube with valve crosslinked with isocyanate was obtained (IC 5).

Another tube as described above (Material 3) was soaked in 1% solution of glycerol glycidyl amine representing a compound having both hydroxyl and straight-chained ether bonding, for 24 hours and then it was freeze-dried. Next, the tube which was treated as described, was put into 3.0% hexamethylene diisocyanate/methanol solution which also contained 1,3-diamino-2-hydroxypropane, and was crosslinked for three hours before it was thoroughly rinsed with distilled water. Thus a tube crosslinked with isocyanate, also bonded with hydroxyl and ether bonding at the crosslinked site was obtained. Further, the tube was treated with protamine in the same manner as described before, and was heparinized in the same manner as the crosslinked tube with glutaraldehyde. Thus, a heparinized tube with valve crosslinked with isocyanate and bonded with hydroxyl and ether bonding was obtained (IC 6).

Another tube from above noted (Material 3) was put into 0.1M sodium carbonate 50% ethanol solution (pH 11.5-11.8) and 5.0% ethylene glycol glycidyl ether (EX810 from Nagase Chemical Co., Ltd., Japan) was added and the tube was crosslinked for five hours, followed by thorough rinsing with distilled water. Thus a tube crosslinked with epoxy was obtained. Further, the tube was treated with protamine in the same manner as described earlier, and was also heparinized as the same way as crosslinked tube with glutaraldehyde. Thus, a heparinized tube with valve crosslinked with epoxy was obtained (EX 5).

Another tube from above (Material 3) was soaked in 1% solution containing glycerol glycidyl amine, representing a compound having both hydroxyl and straight-chained ether bonding, for 24 hours at room temperature. Next, the tube treated as described was put into 0.1M sodium carbonate 50% ethanol solution (pH 11.5-11.8) and 5.0% ethylene glycol glycidyl ether (EX810 from Nagase Chemical Co., Ltd., Japan) was added into the solution, and was crosslinked for five hours. It was then rinsed thoroughly with distilled water. Thus, a tube crosslinked with epoxy and bonded with hydroxyl and ether bonding at the crosslinked site was obtained. Further, the tube was treated with protamine in the same manner as described earlier, and was also heparinized as the same way as crosslinked tube with glutaraldehyde. Thus, a heparinized tube with valve crosslinked with epoxy and bonded with hydroxyl and ether bonding was obtained (EX 6).

### EXAMPLE NO. 12

The tubes added with heparin as in the previous example, namely (Material 5), (GA 5), (GA 6), (IC 5), (IC 6), (EX 5), and (EX 6), were evaluated for their anti-thrombotic effect to the valvular leaves compared to the tubes that were not treated with heparin which are (Material 3), (GA 3), (GA 4), (IC 3), (IC 4), (EX 3), and (EX 4). They were evaluated both macroscopically and by using a scanning electron microscope.

Each tube was filled with fresh blood taken from an adult dog and was left for 30 minutes. Then the blood was removed and the tubes were quietly irrigated with normal saline solution. Then the tubes were cut open in the direction of the long axis and the lumen surface was observed macroscopically. The samples for the scanning electron microscope were created and the adhesion of platelets and fibrin on the lumen surface, particularly at the area of valvular leaves was studied.

As a result, no adhesion of thrombi on the lumen including valvular leaves was found macroscopically for the heparinized tubes. On the contrary, the adhesions of thrombi were found in all the tubes that were not heparinized, although the degree of adhesions was somewhat different among them, and the adhesions of thrombi were significant especially at the area of valvular leaves. Among the tubes without heparin treatment, (Material 3), (EX 3) and (EX 4) showed less adhesions compared to others.

From this, it is clear macroscopically that regardless of the method utilized for crosslinking, the measure to attach heparin via use of protamine was effective in terms of adding anti-thrombotic property.

The observation made by using a scanning electron microscope (JEOL Ltd., Brand name JSM-5310LV) showed innumerable red blood cells caught in the fibrin net for all the tubes that were not heparinized, and the inner surface was covered with fresh thrombi. On the other hand, no fibrin adhesions were acknowledged for all of the heparinized samples, and only scattered platelets were noted.

From this, it was found that regardless of the method utilized for crosslinking, the measure taken to attach heparin via using protamine was able to prevent eduction of fibrin.

### EXAMPLE NO. 13

The tubes obtained from the above examples, namely (GA 3), (GA 4), (EX 3), (EX 4), (GA 5), (GA 6), (EX 5), and (EX 6) were each implanted in adult dogs as a pulmonary artery with valves between the right ventricle and the pulmonary artery. The function of the valve and adhesion of thrombus were evaluated in vivo.

As the surgical technique, the left side of the chest of an adult dog was opened under general anesthesia, and the pericardium was opened and both heart and pulmonary artery were exposed. An incision about 4 cm long was made to the right ventricle and each of the prepared tubes, (GA 3), (GA 4), (EX 3), (EX 4), (GA 5), (GA 6), (EX 5), and (EX 6) was anastomosed with the other end of the tube being anastomosed to the pulmonary artery. Then the pre-existing pulmonary artery was ligated. By this procedure, the blood flow was entirely redirected from the right ventricle to the right pulmonary artery via the tube.

The implantation of each tube was done with ease without any bleeding, and there was no difference among each individual tubes in regards to surgical manipulation. The animals that underwent implantation were all in good health subsequent to the surgery. Four weeks after the surgery, each tube was removed from the animal. During the removal of the tube, the movement of the valve was observed using an ultrasound diagnostic device. Each tube that was extracted, was cut open in the direction of the long axis, and the lumen was studied macroscopically, using optical microscope (100 to 300 magnifications), and also by using a scanning electron microscope (400 to 1500 magnifications).

The observation by the ultrasound diagnostic device (Manufactured by Toshiba Corp, Brand name: Color Doppler ultrasound diagnostic device SSA-340A) showed that all the valves were mobile, but the valve of (GA 3) showed poor mobility. All other valves showed good mobility.

The adhesion of thrombus was acknowledged macroscopically on the valves of (GA 3) and (GA 4). Especially the valve of (GA 3) showed a large thrombus strongly attached to it, and had caused a stenosis in this area of the tube. On the contrary, (EX 3) and (EX 4) showed a very small thrombus which had adhered partially on the inner side of the valve, but no thrombus was found in other parts. Absolutely no adhesion of thrombus was found on the valves of heparinized (GA 5), (GA 6), (EX 5), and (EX 6).

From the optical microscopic observation, fresh thrombus containing large amount of red blood cells was acknowledged for (GA 3) and (GA 4) in the area previously noted macroscopically. The adventitial side of all of (GA 3), (GA 4), (GA 5), (GA 6) which had been treated with glutaraldehyde, showed prominent foreign body giant cells indicating strong foreign body reaction. Against this, the valves of (EX 3), (EX 4), (EX 5), and (EX 6) showed almost no foreign body reaction.

By observing through scanning electron microscope, although there were differences in the thickness of the inner surface among the samples with thrombus, the surface was covered with thrombus uniformly. On the other hand, among the samples where no thrombus was acknowledged, the ones which were not heparinized, namely (EX 3) and (EX 4), showed a thin layer of fibrin covering the inner surface. And as for the valves of heparinized (GA 5), (GA 6), (EX 5), and (EX 6), no eduction of fibrin was acknowledged on the surface, and only platelets were adhered in places. Further, these platelets were almost spherical in shape and no ruptured or adhered platelets were found.

### EXAMPLE NO. 14

Fabric polyester artificial blood vessels (knitted graft, internal diameter 10 mm, length 5 cm and fluid passage rate 3,000 ml/min) were instilled with 100 ml solution of atelo-collagen (pepsin soluble collagen derived from cow's dermis, pH illegible, collagen concentration 1.0%) to clog the pores existing in the space between the fibers of the artificial blood vessels. Then, the artificial blood vessels were self-dried allowing the collagen adhere to the polyester fabric (Material 7).

A collagen-covered artificial blood vessel as described above (Material 7) was put into 1.0% glutaraldehyde/phosphate buffer solution (pH 7.4) and was crosslinked for 30 minutes at room temperature before thoroughly rinsed. Thus, a collagen-covered artificial blood vessel crosslinked with glutaraldehyde was obtained (GA 7).

An artificial blood vessel from (Material 7) noted above, was put in 1.0% glutaraldehyde/phosphate buffer solution (pH 7.4) of which 1% contained glycerol glycidyl amine representing a compound having both hydroxyl and straight-chained ether bonding and its structural formula shown as H₂N (CH₂)₃OCH₂CH(OH)CH₂O(CH₂)₃NH₂. The blood vessel was crosslinked for 30 minutes and was thoroughly rinsed with normal saline solution. Thus a collagen-covered artificial blood vessel crosslinked with glutaraldehyde and also bonded with hydroxyl and ether bonding was obtained (GA 8).

An artificial blood vessel from (Material 7) noted above, was freeze-dried and was put into 3.0% hexamethylene diisocyanate/methanol solution also containing 1,3-diamino-2-hydropropane and was crosslinked for one hour followed by thorough rinsing with distilled water. Thus, a collagen-covered artificial blood vessel crosslinked with isocyanate was obtained (IC 7).

An artificial blood vessel from (Material 7) was soaked in 1% solution of glycerol glycidyl amine representing a compound having both hydroxyl and straight-chained ether bonding, for 24 hours at room temperature. The blood vessel was then freeze-dried. Next, the blood vessel treated as described, was put in 3.0% hexamethylene diisocyanate/methanol solution also containing 1,3-diamino-2-hydroxypropane, and was crosslinked for one hour at room temperature before being thoroughly rinsed with distilled water. Thus, a collagen-covered artificial blood vessel crosslinked with isocyanate and also bonded with hydroxyl and ether bonding at the crosslinked site was obtained (IC 8).

An artificial blood vessel from (material 7) noted above, was freeze-dried and was put into 0.1M sodium carbonate 50% ethanol solution (pH 11.5-11.8). 5.0% ethylene glycol diglycidyl ether (EX810 from Nagase Chemical Co., Ltd., Japan) was added and crosslinked for two hours before being thoroughly rinsed with distilled water. Thus, a collagen-covered artificial blood vessel crosslinked with epoxy was obtained (EX 7).

An artificial blood vessel from (Material 7) noted above, was soaked in 1% solution of glycerol glycidyl amine selected as representing a compound having both hydroxyl and straight-chained ether bonding, for 24 hours at room temperature. Next, the artificial blood vessel treated as described, was put into 0.1M sodium carbonate 50% ethanol solution (pH 11.5-11.8) and 5.0% ethylene glycol diglycidyl ether was added. The blood vessel was crosslinked for three hours and was rinsed thoroughly with distilled water. Thus, a collagen-covered artificial blood vessel crosslinked with epoxy and also bonded with hydroxyl and ether bonding at the crosslinked site was obtained (EX 8).

### EXAMPLE NO. 15

The collagen-covered artificial blood vessels obtained as in the previous example, namely (Material 7), (GA 7), (GA 8), (IC 7), (IC 8), (EX 7), and (EX 8), were observed for their resistance against the digestion by collagenase. As a method, each of (Material 7), (GA 7), (GA 8), (IC 7), (IC 8), (EX 7) and (EX 8) were separately soaked in phosphate buffer solution containing 0.01% collagenase with pH 7.4 and were observed in room temperature.

As a result, the collagen adhered in the (Material 7) was all digested within one day, but the collagen adhered to other artificial blood vessels was not resolved even after three days. However, when the collagenase solution was changed fresh and the solution was stirred using an agitator, the remaining collagen adhered to all the rest of artificial blood vessels was resolved completely within 14 days.

This result, regardless of the crosslinking agents, indicated the resistance that the crosslinking process has against resolving property of collagenase, and it was suggested that by slightly shortening the duration of crosslinking, one can allow the collagen to be resolved and absorbed in a biological body.

### EXAMPLE NO. 16

Each collagen-covered artificial blood vessels from the above example, (Material 7), (GA 7), (GA 8), (IC 7), (IC 8), (EX 7), and (EX 8), was implanted in vivo and the evaluation for use as collagen-covered artificial blood vessels was performed.

The descending aorta in the chest of an adult dog was removed in the length of 5 cm, and the collagen-covered artificial blood vessels, (Material 7), (GA 7), (GA 8), (IC 7), (IC 8), (EX 7), and (EX 8) were implanted.

As a result, all the artificial blood vessels were implanted with ease, and there was no bleeding from the walls of the artificial blood vessels.

During the post-implantation progress, the dog that received implantation of (Material 7) died the next day in the condition of hemothorax. As a result of autopsy, it was found that the layer of the collagen covering the artificial blood vessel had come off exposing the artificial blood vessel in many areas. The cause of death was a massive bleeding from the wall of the artificial blood vessel.

As to the other animals, the artificial blood vessels were removed from them two months post-operatively. As a result, most of the samples showed the inner surface of the anastomosed area being continuously covered with endothelial cells. In the middle area of the artificial blood vessels showed thick thrombi covering the inner surface.

The examination by an optic microscope (100˜300 magnifications) revealed that among the collagen-covered artificial blood vessels, (Material 7) (GA 7), (GA 8), (IC 7), (IC 8), (EX 7), and (EX 8), some collagen had remained on the blood vessels, (GA 7), (GA 8) (IC 7), and (IC 8) although the amount was small. The foreign body giant cells were also found in the surrounding indicating a foreign body reaction. However, no calcification was acknowledged.

On the other hand, the collagen which existed in (EX 7) and (EX 8) was completely absorbed and there was no foreign body reaction in the area, nor any calcification.

From this, it was possible to reduce the level of crosslinking by shortening the duration of crosslinking, and also collagen can be resolved completely within a live body.

### EXAMPLE NO. 17

Each of the collagen-covered blood vessels, (Material 7), (GA 7), (GA 8), (IC 7), (IC 8), (EX 7), and (EX 8) noted in previous examples, was cut open in the direction of the long axis and was cut into the size of 3 cm×5 cm to be used as the patch materials with polyester mesh covered with collagen. Then, the implantation of the materials in vivo was performed and they were evaluated for its usage as a collagen-covered patch.

The left side of the chest of an adult dog was opened and the pericardium was exposed. The pericardium was partially excised, and each of the collagen-covered patches, (Material 7), (GA 7), (GA 8), (IC 7), (IC 8), (EX 7), and (EX 8), was implanted as an artificial pericardium.

As a result, all the patch materials were implanted with ease.

Two months post-operatively, the patches were removed from the animals. It was found that although slight adhesions were found in the sutured areas in most of the samples, almost no adhesions were found on the membrane surfaces, and the inner side of the patch revealed serous cells covering from the sutured area in a continuous manner.

The examination by an optic microscope (100 to 300 magnifications) of the samples (GA 7) (GA 8), (IC 7), (IC 8), (EX 7), and (EX 8) revealed that the collagen had remained on (GA 7), (GA 8), (IC 7) and (IC 8) although the amount was small, and foreign body giant cells were identified in the surrounding area indicating foreign body reactions. No calcifications were observed.

On the other hand, the collagen of both (EX 7) and (EX 8) was completely absorbed and no foreign body reaction was found in the area, nor any calcifications was acknowledged.

As a result, when the level of crosslinking is kept low by shortening the duration of crosslinking, it is possible to create collagen-covered patches that are capable of allowing the collagen used for patching in a live body to be completely absorbed.

So far, the examples that have been applied were explained, but the present invention is not limited to these examples and obvious alterations are possible in view of the disclosure herein as long as the configuration and the quality of the material do not deviate far below that which has been shown herein.

Summary

As it was described above, as a result of crosslinking a natural material or material which has one selected derivative of the natural material as its structural components, a chemically crosslinked material of which hydroxyl group and/or straight-chained ether bond has newly increased, can be provided. Such chemically crosslinked materials demonstrate favorable antigenicity/flexibility balance deriving in large part from the newly introduced hydroxyl group and/or straight-chained ether bond.

Further, by adding preferred enhancer compounds, including H₂N—R(OH)—NH₂, HO—R—NH₂, H₂N—R—O—R—NH, H₂N—R(OH)—O—R—NH, HO—R—O—R—NH₂, to the crosslinking process, the crosslinked material having additional hydroxyl group and/or straight-chained ether bond can be obtained.

These effects can be obtained by using the crosslinking agents such as aldehydes, isocyanates, and epoxy compounds, for example.

Tissue materials harvested from animals can be not only tubular materials such as blood vessels, ureters, esophagus, small intestine, large intestine, bronchial tube, neural sheaths, and tendons, it also can be membrane materials such as cerebral dura mater, pericardium, amnion, cornea, mesentery, peritoneum, chest membrane, pleura, diaphragm, bladder wall, fascia, aponeurosis, and velamentum. They can also be valvular materials such as heart valves and venous valves, and any other material, natural or derived from natural sources, which is amenable to the types of reactions described herein.

Further, even if the material is something that is harvested from an animal, and is a product obtained from smashed skin or tendon such as minute fibriform collagen, for example, the material equipped with the above mentioned characteristics can be provided by the crosslinking method.

Additionally, as the need arises, one can combine finely smashed minute fibers as disclosed with synthetic macromolecular materials, for example, collagen-covered artificial blood vessels or collagen-covered patches.

The chemically crosslinked materials can be provided as crosslinked material with such characteristics as having significantly improved flexibility compared to the traditional products, causing low incidence of foreign body reactions, and having greater flexibility.

From the foregoing description, it should be appreciated that a novel chemically crosslinked material and process of manufacture have been disclosed. While the invention has been described with reference to specific embodiments, the description is merely illustrative and is not to be construed as limiting in any way. Various modifications and applications of what is disclosed herein may occur to those who are skilled in the art following review of the description herein, without departing from the true spirit or scope of the invention. The breadth and scope of the invention should be defined in accordance with the appended claims and their equivalents.

What is claimed is:

1. A chemically crosslinked material, comprising a natural material or a derivative thereof having crosslinks formed by the combination of a primary crosslinking agent and an enhancer compound, wherein the enhancer compound provides at least one additional hydroxyl group and/or at least one additional linear ether linkage as compared to crosslinks formed by the primary crosslinking agent alone.

2. The chemically crosslinked material according to claim 1, wherein the enhancer comprises a compound represented by a chemical formula selected from the group consisting of H₂N—R(OH)—NH₂, HO—R—NH₂, H₂N—R—O—R—NH₂, H₂N—R(OH)—O—R—NH₂, and HO—R—O—R—NH, wherein R is a substituted or unsubstituted chain comprising 1-8 atoms selected from carbon, oxygen and nitrogen.

3. The chemically crosslinked material according to claim 2, wherein the enhancer is selected from the group consisting of 1,3-diamino-2-hydroxypropane, glucosamine, galactosamine, chitosan, triethyleneglyceroldiamine, glycerol glycidyl amine, and 2(2-aminoethoxy)ether.

4. The chemically crosslinked material according to claim 1, wherein the primary crosslinking agent comprises an aldehyde compound selected from the group consisting of formaldehyde, glutaraldehyde, and dialdehyde starch.

5. The chemically crosslinked material according to claim 1, wherein the primary crosslinking agent comprises an isocyanate compound selected from the group consisting of hexamethylene diisocyanate, and triethylene diisocyanate.

6. The chemically crosslinked material according to claim 1, wherein the primary crosslinking agent comprises an epoxy compound selected from the group consisting of glycerol triglycidyl ether, ethylene glycol diglycidyl ether, polypropylene glycol diglycidyl ether, trimethylol propane polyglycidyl ether, diglycerol polyglycidyl ether, polyglycerol polyglycidyl ether, and sorbitol polyglycidyl ether.

7. The chemically crosslinked material according to claim 1, wherein said material is processed with glycine after chemical crosslinking.

8. The chemically crosslinked material according to claim 1, wherein said natural material and derivatives thereof is a material from a human or animal, or a derivative thereof.

9. The chemically crosslinked material according to claim 8, wherein said natural material and derivatives thereof is a tubular material selected from the group consisting of blood vessels, urinary ducts, the esophagus, small intestine, large intestine, luftrohre, perineurium, and peritendon.

10. The chemically crosslinked material according to claim 8, wherein said natural material and derivatives thereof is a membrane material selected from the group consisting of cerebral dura mater, cardiac sac membrane, amniotic membrane, cornea, mesenterum, peritoneum, pleura, diaphragm, urinary bladder membrane, fascia, aponeurosis, and chorion.

11. The chemically crosslinked material according to claim 8, wherein said natural material and derivatives thereof is a valvular material selected from heart valves and venous valves.

12. The chemically crosslinked material according to claim 8, wherein said natural material and derivatives thereof is a tendon or skin.

13. The chemically crosslinked material according to claim 12, wherein said tendon or skin is in comminuted form.

14. The chemically crosslinked material according to claim 1, wherein said natural material and derivatives thereof is a structure formed from solution or dispersing agent comprising collagen or collagen derivative.

15. The chemically crosslinked material according to claim 14, wherein said structure is in a form selected from the group consisting of membrane, in placibis, cyclic, tubular, globular, powdery, spongy, filamentous, and fibrous.

16. The chemically crosslinked material according to claim 1, further comprising protamine covalently bonded to said natural material, wherein heparin is ionically bonded to said protamine.

17. The chemically crosslinked material according to claim 1, wherein said material is in the form of a material selected from the group consisting of artificial cerebral dura mater, artificial connective tissue, artificial pleura, artificial pleura wall, artificial skin, artificial hypodermis-subcutaneous tissue, artificial chest wall, artificial diaphragm, artificial peritoneum, artificial abdominal wall, anti-adhesion membrane, artificial urinary bladder, artificial cardiac sac membrane, artificial cardiac wall, artificial blood vessel, artificial luftrohre, artificial esophagus, artificial tendon, artificial fascia, and agents to promote wound healing.

18. The chemically crosslinked material according to claim 13, further comprising a macromolecular material that incorporates said comminuted material, the macromolecular material being in a form selected from the group consisting of in placibis, membrane, cyclic, tubular, bar, filamentous, woven materials, knitted materials, stretched materials, and mesh materials.

19. The chemically crosslinked material according to claim 18, wherein said macromolecular material comprises a natural material or at least a part of a natural material.

20. The chemically crosslinked material according to claim 18, wherein said material is porous or non-porous.

21. The chemically crosslinked material according to claim 18, wherein said macromolecular material comprises a material formed at least in part by a compound represented by a chemical formula selected from the group consisting of H₂N—R(OH)—NH₂, HO—R—NH₂, H₂N—R—O—R—NH₂, H₂N—R(OH)—O—R—NH₂, and HO—R—O—R—NH₂, wherein R is a substituted or unsubstituted chain comprising 1-8 atoms selected from carbon, oxygen and nitrogen.

22. The chemically crosslinked material according to claim 18, wherein the macromolecular material is decomposed and absorbed in vivo within 6 months after implantation into the body of a mammal.

23. The chemically crosslinked material according to claim 18, wherein the macromolecular material is neither decomposed nor absorbed in vivo within 6 months after implantation into the body of a mammal.

24. The chemically crosslinked material according to claim 18, wherein said material is in the form of a material selected from the group consisting of artificial cerebral dura mater, artificial connective tissue, artificial pleura, artificial pleura wall, artificial skin, artificial hypodermis-subcutaneous tissue, artificial chest wall, artificial diaphragm, artificial peritoneum, artificial abdominal wall, anti-adhesion membrane, artificial urinary bladder, artificial cardiac sac membrane, artificial cardiac wall, artificial blood vessel, artificial luftrohre, artificial esophagus, artificial tendon, artificial fascia, and agents to promote wound healing.

25. A chemically crosslinked material, comprising a natural material or a derivative thereof having crosslinks formed therein, wherein said crosslinks comprise those formed by the combination of
a primary crosslinking agent selected from the group consisting of aldehydes, isocyanates and epoxies; and
an enhancer compound, represented by a chemical formula selected from the group consisting of H₂N—R(OH)—NH₂, HO—R—NH₂, H₂N—R—O—R—NH₂, H₂N—R(OH)—O—R—NH₂, and HO—R—O—R—NH₂, wherein R is a substituted or unsubstituted chain comprising 1-8 atoms selected from carbon, oxygen and nitrogen;
wherein said crosslinks include at least one additional hydroxyl group and/or at least one additional linear ether linkage as compared to crosslinks formed by the primary crosslinking agent alone.

26. The chemically crosslinked material according to claim 25, wherein the enhancer is selected from the group consisting of 1,3-diamino-2-hydroxypropane, glucosamine, galactosamine, chitosan, triethyleneglyceroldiamine, glycerol glycidyl amine, and 2(2-aminoethoxy)ether.

27. The chemically crosslinked material according to claim 25, wherein the primary crosslinking agent comprises a compound selected from the group consisting of formaldehyde, glutaraldehyde, dialdehyde starch, hexamethylene diisocyanate, triethylene diisocyanate, glycerol triglycidyl ether, ethylene glycol diglycidyl ether, polypropylene glycol diglycidyl ether, trimethylol propane polyglycidyl ether, diglycerol polyglycidyl ether, polyglycerol polyglycidyl ether, and sorbitol polyglycidyl ether.

27. A chemically crosslinked material, comprising
a collagen-containing material, said material having multiple crosslinks between collagen strands, wherein
said crosslinks comprise enhanced crosslinks formed by the combination of a primary crosslinking agent and an enhancer compound,
wherein said enhanced crosslinks include at least one additional hydroxyl group and/or at least one additional linear ether linkage as compared to crosslinks formed by the primary crosslinking agent alone.

28. The chemically crosslinked material according to claim 27, wherein the enhancer comprises a compound represented by a chemical formula selected from the group consisting of H₂N—R(OH)—NH₂, HO—R—NH₂, H₂N—R—O—R—NH₂, H₂N—R(OH)—O—R—NH₂, and HO—R—O—R—NH₂, wherein R is a substituted or unsubstituted chain comprising 1-8 atoms selected from carbon, oxygen and nitrogen.

29. The chemically crosslinked material according to claim 28, wherein the enhancer is selected from the group consisting of 1,3-diamino-2-hydroxypropane, glucosamine, galactosamine, chitosan, triethyleneglyceroldiamine, glycerol glycidyl amine, and 2(2-aminoethoxy)ether.

30. The chemically crosslinked material according to claim 27, wherein the primary crosslinking agent comprises a compound selected from the group consisting of formaldehyde, glutaraldehyde, dialdehyde starch, hexamethylene diisocyanate, triethylene diisocyanate, glycerol triglycidyl ether, ethylene glycol diglycidyl ether, polypropylene glycol diglycidyl ether, trimethylol propane polyglycidyl ether, diglycerol polyglycidyl ether, polyglycerol polyglycidyl ether, and sorbitol polyglycidyl ether.

31. The chemically crosslinked material according to claim 27, wherein said collagen-containing material is selected from the group consisting of blood vessels, urinary ducts, esophagus, small intestine, large intestine, luftrohre, perineurium, and peritendon, cerebral dura mater, cardiac sac membrane, amniotic membrane, cornea, mesenterum, peritoneum, pleura, diaphragm, urinary bladder membrane, fascia, aponeurosis, chorion, heart valves, venous valves, tendon, and skin.

32. A method for preparing a chemically crosslinked material, the method comprising:
crosslinking a natural material or a derivative thereof with a primary crosslinking agent and an enhancer compound, wherein crosslinks formed by crosslinking comprise crosslinks which include at least one additional hydroxyl group and/or at least one additional linear ether linkage as compared to crosslinks formed by the primary crosslinking agent alone.

33. The method according to claim 32, wherein the enhancer comprises a compound represented by a chemical formula selected from the group consisting of H₂N—R(OH)—NH₂, HO—R—NH₂, H₂N—R—O—R—NH₂, H₂N—R(OH)—O—R—NH₂, and HO—R—O—R—NH₂, wherein R is a substituted or unsubstituted chain comprising 1-8 atoms selected from carbon, oxygen and nitrogen.

34. The method according to claim 33, wherein the enhancer is selected from the group consisting of 1,3-diamino-2-hydroxypropane, glucosamine, galactosamine, chitosan, triethyleneglyceroldiamine, glycerol glycidyl amine, and 2(2-aminoethoxy)ether.

35. The method according to claim 32, wherein the primary crosslinking agent comprises an aldehyde compound selected from the group consisting of formaldehyde, glutaraldehyde, and dialdehyde starch.

36. The method according to claim 32, wherein the primary crosslinking agent comprises an isocyanate compound selected from the group consisting of hexamethylene diisocyanate, and triethylene diisocyanate.

37. The method according to claim 32, wherein the primary crosslinking agent comprises an epoxy compound selected from the group consisting of glycerol triglycidyl ether, ethylene glycol diglycidyl ether, polypropylene glycol diglycidyl ether, trimethylol propane polyglycidyl ether, diglycerol polyglycidyl ether, polyglycerol polyglycidyl ether, and sorbitol polyglycidyl ether.

38. The method according to claim 32, further comprising processing with glycine after crosslinking.

39. A method for preparing chemically crosslinked collagenous material, comprising:
placing collagen or collagenous tissue in a solvent; and
adding crosslink forming materials to the solvent, said crosslink forming materials comprising:
a primary crosslinking agent selected from the group consisting of aldehydes, isocyanates and epoxies; and
an enhancer compound, represented by a chemical formula selected from the group consisting of H₂N—R(OH)—NH₂, HO—R—NH₂, H₂N—R—O—R—NH₂, H₂N—R(OH)—O—R—NH₂, and HO—R—O—R—NH₂, wherein R is a substituted or unsubstituted chain comprising 1-8 atoms selected from carbon, oxygen and nitrogen;
whereby crosslinked material is formed.

40. The method according to claim 39, wherein the enhancer is selected from the group consisting of 1,3-diamino-2-hydroxypropane, glucosamine, galactosamine, chitosan, triethyleneglyceroldiamine, glycerol glycidyl amine, and 2(2-aminoethoxy)ether.

41. The method according to claim 39, wherein the primary crosslinking agent comprises a compound selected from the group consisting of formaldehyde, glutaraldehyde, dialdehyde starch, hexamethylene diisocyanate, triethylene diisocyanate, glycerol triglycidyl ether, ethylene glycol diglycidyl ether, polypropylene glycol diglycidyl ether, trimethylol propane polyglycidyl ether, diglycerol polyglycidyl ether, polyglycerol polyglycidyl ether, and sorbitol polyglycidyl ether.

42. The method according to claim 39, wherein substantially all of the enhancer compound is added to the solvent and left in contact therewith for about 5 to about 30 hours prior to the addition of the primary crosslinking agent.

43. The method according to claim 39, wherein the enhancer and the primary crosslinking agent are added together.

44. The method according to claim 39, further comprising soaking the crosslinked material in a solution of protamine and heparin.

45. The method according to claim 39, further comprising processing the crosslinked material with glycine.
